(19) United States
(12) Patent Application Publication
(10) Pub. No.: US 2015/0275817 A1
(43) Pub. Date: Oct. 1, 2015

(54) ENGINE

(71) Applicant: KUBOTA Corporation, Osaka (JP)

(72) Inventors: Yuki YOSHITA, Osaka (JP); Masato UEDA, Osaka (JP); Wataru MIYAUCHI, Osaka (JP); Masayuki TOCHIMOTO, Osaka (JP); Takashi HANADA, Osaka (JP)

(21) Appl. No.: 14/641,505

(22) Filed: Mar. 9, 2015

(30) Foreign Application Priority Data
Mar. 31, 2014 (JP) 2014-071076
Feb. 25, 2015 (JP) 2015-034835

(51) Int. Cl. F02D 41/40; F02D 41/00

(52) U.S. Cl. CPC F02D 41/403; F02D 41/005

(57) ABSTRACT

There is provided an engine having a fuel injection device with an extended useful life. The engine includes a controller and the fuel injection device, the fuel injection device carrying out a fuel injection by a control by the controller, wherein the main injection is carried out without the pre-injection in a rated operation area and the pre-injection and the main injection are carried out in other operation areas by the control by the controller. An interval between an end of the pre-injection and a start of the main injection is set to a longer period in each of the maximum torque operation area and the medium load operation area than in the light load operation area by the control by the controller.

### BACKGROUND OF THE INVENTION

(1) Field of the Invention

The present invention relates to an engine.

(2) Description of Related Art

A conventional engine may carry out a pre-injection and a main injection in every operation area in some cases.

### Problem

The useful life of the fuel injection device is shortened.

If a pre-injection and a main injection are carried out in every operation area, it results in too many fuel injections, which shortens the useful life of the fuel injection device.

### SUMMARY OF THE INVENTION

An object of the present invention is to provide an engine having a fuel injection device with an extended useful life.

Matters specifying an invention according to the present invention are as follows.

An engine includes a controller and a fuel injection device, the fuel injection device carrying out a fuel injection by a control by the controller,

wherein an operation area is divided into a rated operation area including a rated point where a maximum output can be obtained, a maximum torque operation area including a maximum torque point where maximum torque can be obtained, a medium load operation area, and a light load operation area, the rated operation area is an area close to high speed and high load, the maximum torque operation area is an area closer to low speed and the high load than the rated operation area, the medium load operation area is an area closer to the low speed than the rated operation area and closer to the light load than the maximum torque operation area, the light load operation area is an area closer to the light load than the medium load operation area, and,

the main injection is carried out without the pre-injection in the rated operation area and the pre-injection and the main injection are carried out in the other operation areas by the control by the controller.

The invention exerts the following effects.

### Effect

It is possible to extend a useful life of the fuel injection device.

As compared with a case in which the pre-injection and the main injection are carried out in the all operation areas, the number of fuel injections can be reduced, which extends the useful life of the fuel injection device.

Especially in an industrial engine which is used for a long time in the rated operation area, the effect is outstanding.

### Effect

It is possible to reduce PM and NOx.

In the other operation areas than the rated operation area, PM can be reduced by increase in an air utilization rate and NOx can be reduced by slow combustion.

### BRIEF DESCRIPTION OF THE DRAWINGS

FIG. 1 is a schematic diagram of a diesel engine according to an embodiment of the present invention; and

FIGS. 2A to 2C are diagrams for explaining fuel injections in respective operation areas of the engine in FIG. 1, wherein FIG. 2A shows the operation areas, FIG. 2B shows a list of fuel injection patterns and the like in the respective operation areas, and FIG. 2C shows timeline charts of the fuel injections in the respective operation areas.

### DETAILED DESCRIPTION OF PREFERRED EMBODIMENT

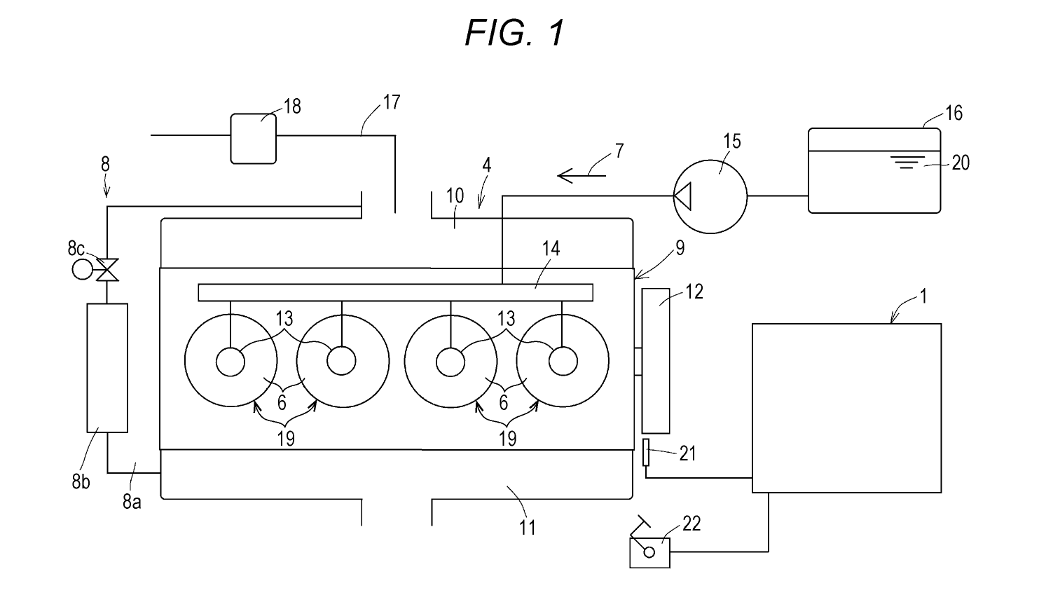

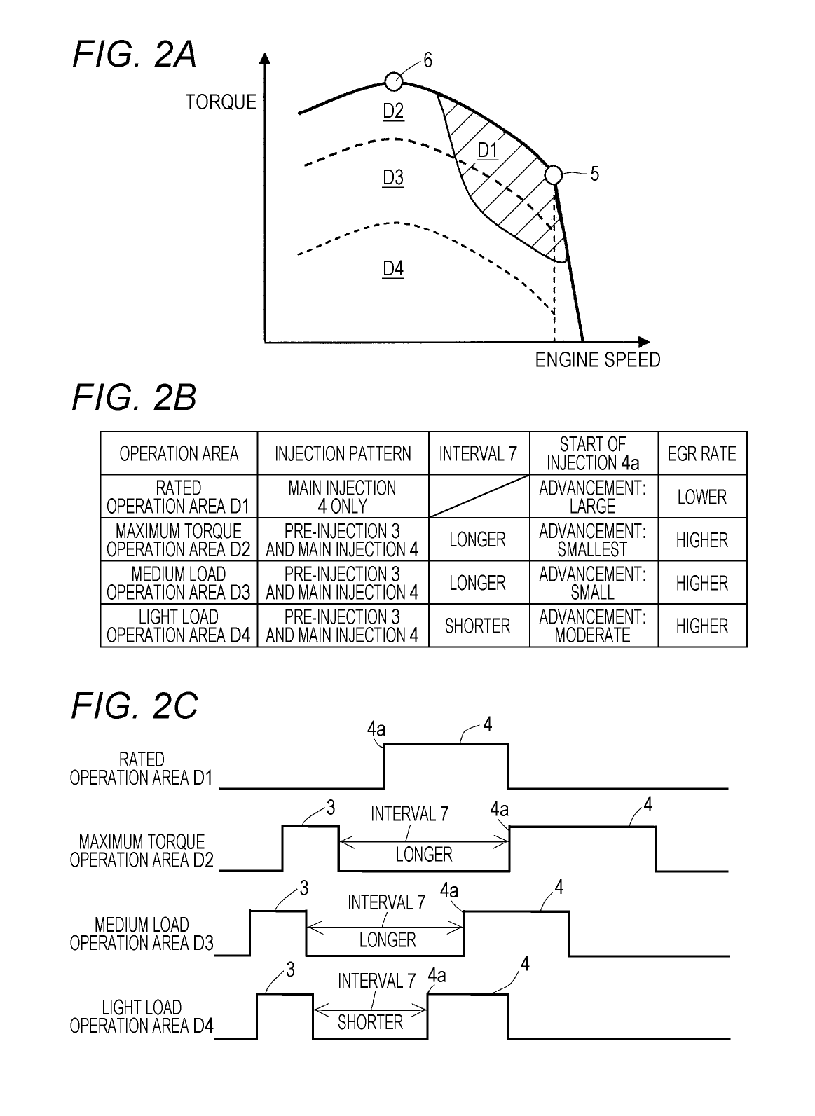

FIGS. 1 and 2A to 2C are diagrams for explaining an engine according to an embodiment of the present invention and the vertical inline four-cylinder diesel engine will be described in the embodiment.

As shown in FIG. 1, the engine includes four cylinders (19) and a cylinder head (9), an intake manifold (10) is mounted to one of left and right sides of the cylinder head (9), an exhaust manifold (11) is mounted to the other side. At a rear portion of a cylinder block (not shown) having the cylinders (19), a flywheel (12) is disposed.

A fuel injection device (2) has a following structure.

As shown in FIG. 1, in the cylinder head (9), an injector (13) is disposed for each of the cylinders (19) and each of the injectors (13) is connected to a common rail (14). Into the common rail (14), fuel (20) in a fuel tank (16) is pumped through a fuel supply pump (15). A solenoid valve of each of the injectors (13) is connected to a controller (1), valve opening timing and a valve opening period are controlled by control signals from the controller (1), and a predetermined amount of fuel (20) is injected into each of combustion chambers (6) at a predetermined timing.

As shown in FIG. 1, a rotation speed sensor (21) and a speed regulation sensor (22) are connected to the controller (1) and a set rotation speed of the engine and a deviation of an actual rotation speed from the set rotation speed are used to adjust a fuel injection amount.

The controller (1) is an engine ECU. The engine ECU is an abbreviation of the engine electronic control unit and is a microcomputer.

An intake flow rate sensor (18) is disposed on an intake path (17) for supplying intake air into the intake manifold (10).

The controller (1) and the fuel injection device (2) are provided as shown in FIG. 1 and the fuel injection device (2) carries out fuel injections (3) and (4) by the control by the controller (1) as shown in FIGS. 2B and 2C.

As shown in FIG. 2A, in a coordinate system formed by a horizontal axis representing the engine rotation speed and a vertical axis representing torque, an operation area is divided into a rated operation area (D1) including a rated point (5) where the maximum output can be obtained, a maximum torque operation area (D2) including a maximum torque point (6) where the maximum torque can be obtained, a medium load operation area (D3), and a light load operation area (D4). The rated operation area (D1) is an area close to high speed and high load, the maximum torque operation area (D2) is an area closer to low speed and the high load than the rated operation area (D1), the medium load operation area (D3) is an area closer to the low speed than the rated operation area (D1) and closer to the light load than the maximum torque operation area (D2), and the light load operation area (D4) is an area closer to the light load than the medium load operation area (D3). Division of operation areas and identification of the operation areas during operation are performed by the controller (1).

The fuel injection device (2) is a common rail system as described above.

As shown in FIGS. 2B and 2C, the main injection (4) is carried out without the pre-injection (3) in the rated operation area (D1) and the pre-injection (3) and the main injection (4) are carried out in each of the other operation areas (D2), (D3), and (D4) during a single combustion cycle by the control by the controller (1).

Therefore, as compared with a case in which the pre-injection (3) and the main injection (4) are carried out in each of the all operation areas (D1), (D2), (D3), and (D4), the number of fuel injections (3), (4) can be reduced, which extends the useful life of the fuel injection device (2).

Especially in an industrial engine which is used for a long time in the rated operation area (D1), the effect is outstanding.

Further, in the other operation areas (D2), (D3), and (D4) than the rated operation area (D1), PM can be reduced by increase in an air utilization rate and NOx can be reduced by slow combustion.

The main injection (4) represents a primary fuel injection for obtaining engine output and the pre-injection (3) represents a fuel injection which precedes the main injection (4) and is carried out for improving combustion of the main injection (4).

As shown in FIGS. 2B and 2C, by the control by the controller (1), an interval (7) between an end of the pre-injection (3) and a start of the main injection (4) is set to a longer period in each of the maximum torque operation area (D2) and the medium load operation area (D3) than in the light load operation area (D4). Therefore, combustion pressure increases slowly and NOx can be reduced. Length of the interval (7) is set based on a crank angle difference. The interval (7) is set to a longer period when the crank angle difference is greater while the interval (7) is set to a shorter period when the crank angle difference is smaller.

As shown in FIGS. 2B and 2C, by the control by the controller (1), injection start timing (4a) of the main injection (4) is further advanced in the rated operation area (D1) than in the other operation areas (D2), (D3), and (D4). In this case, ignition delay is suppressed, afterburning is suppressed, and PM can be reduced. At the same time, the combustion pressure increases slowly and NOx can be reduced. Advancement of the injection start timing (4a) of the main injection (4) is large in the rated operation area (D1), moderate in the light load operation area (D4), small in the medium load operation area (D3), and the smallest in the maximum torque operation area (D2).

An EGR device (8) is provided as shown in FIG. 1 and, by the control by the controller (1) as shown as an example in FIG. 2B, an EGR rate is set to a lower value in the rated operation area (D1) than in the other operation areas (D2), (D3), and (D4). Therefore, the engine output is increased. Further, an excess air ratio increases and PM can be reduced.

The EGR device (8) is provided between the exhaust manifold (11) and the intake manifold (10) and includes an EGR cooler (8b) and an EGR valve (8c) at some points on an EGR passage (8a). By the control by the controller (1), an opening degree of the EGR valve (8c) is adjusted and the EGR rate is set.

What is claimed is:

1. An engine comprising a controller and a fuel injection device, the fuel injection device carrying out a fuel injection by a control by the controller,
wherein an operation area is divided into a rated operation area including a rated point where a maximum output can be obtained, a maximum torque operation area including a maximum torque point where maximum torque can be obtained, a medium load operation area, and a light load operation area, the rated operation area is an area close to high speed and high load, the maximum torque operation area is an area closer to low speed and the high load than the rated operation area, the medium load operation area is an area closer to the low speed than the rated operation area and closer to the light load than the maximum torque operation area, the light load operation area is an area closer to the light load than the medium load operation area, and
a main injection is carried out without a pre-injection in the rated operation area and the pre-injection and the main injection are carried out in the other operation areas by the control by the controller.

2. The engine according to claim 1,
wherein an interval between an end of the pre-injection and a start of the main injection is set to a longer period in each of the maximum torque operation area and the medium load operation area than in the light load operation area by the control by the controller.

3. The engine according to claim 1,
wherein injection start timing of the main injection is further advanced in the rated operation area than in the other operation areas by the control by the controller.

4. The engine according to claim 1 further comprising an EGR device,
wherein an EGR rate is set to a lower value in the rated operation area than in the other operation areas by the control by the controller.

5. The engine according to claim 2,
wherein injection start timing of the main injection is further advanced in the rated operation area than in the other operation areas by the control by the controller.

6. The engine according to claim 2 further comprising an EGR device,
wherein an EGR rate is set to a lower value in the rated operation area than in the other operation areas by the control by the controller.

7. The engine according to claim 3 further comprising an EGR device,
wherein an EGR rate is set to a lower value in the rated operation area than in the other operation areas by the control by the controller.

8. The engine according to claim 5 further comprising an EGR device,
wherein an EGR rate is set to a lower value in the rated operation area than in the other operation areas by the control by the controller.
